(19) United States
(12) Patent Application Publication
(10) Pub. No.: US 2003/0185204 A1
(43) Pub. Date: Oct. 2, 2003

(54) Data communication system combining pay telephone and wireless access technologies

(76) Inventor: Scott D. Murdock, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/400,294

(22) Filed: Mar. 25, 2003

Related U.S. Application Data
(60) Provisional application No. 60/369,450, filed on Apr. 1, 2002.

(51) Int. Cl. H04L 12/28

(52) U.S. Cl. 370/352; 370/310

(57) ABSTRACT

A public wireless data communication system is obtained by combining pay telephone and wireless data communication technologies. The system may be used to connect a wireless user access device to the Internet and/or other wide area or local area communications networks. A pay telephone includes a local loop connected to a public switched telephone network (PSTN). The local loop may be multiplexed to provide simultaneous wireless data communication and telephone call services. In one implementation, data communications equipment (e.g., an xDSL router/modem) and a wireless access point (e.g., an IEEE 802.11 access point) are connected to the pay telephone's local loop to provide access to the Internet through an Internet service provider. Increased wireless data communication speed and bandwidth are achieved without requiring allocation of additional scarce, government-controlled spectrum.

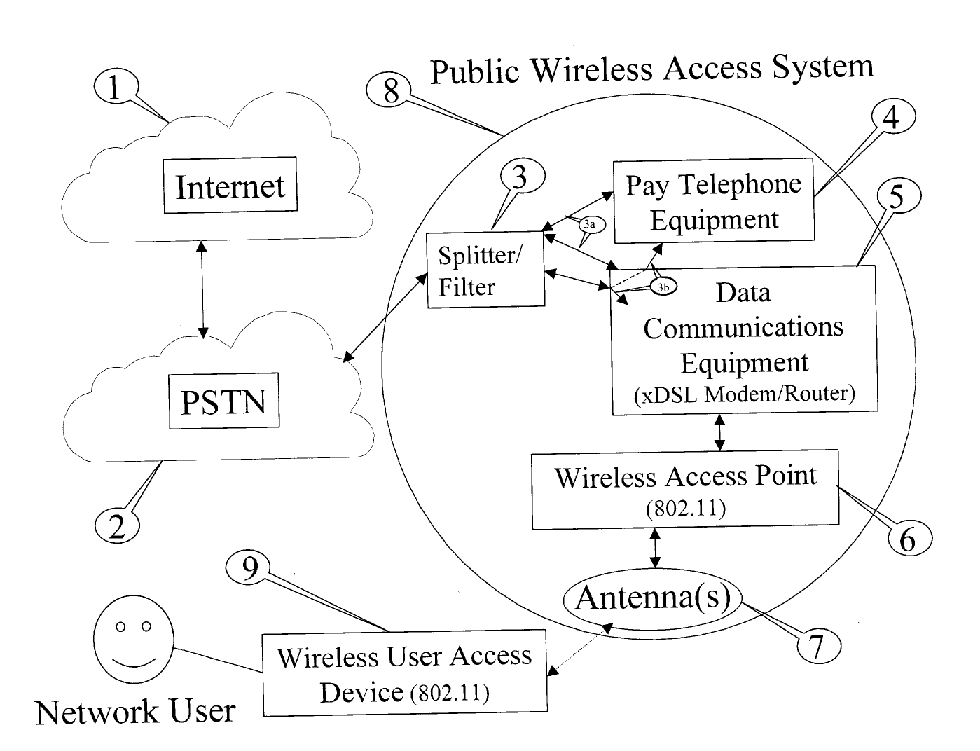

### CROSS-REFERENCE TO RELATED APPLICATION

This application claims the benefit of the filing date of U.S. Provisional Application No. 60/369,450, filed Apr. 1, 2002, the entire disclosure of which is incorporated by reference herein.

### FIELD OF THE INVENTION

The present invention relates to the field of data communication and involves a combination of public pay telephones with wireless data communication technology.

### BACKGROUND OF THE INVENTION

In the past, a network of publicly accessible pay telephones has been developed that provides circuit switched access to the public switched telephone network (PSTN). Pay telephones are utilized for both voice and computer communications and are activated by both cash and credit methods. These devices have contributed greatly to general public communications, commerce and safety. However, with advent of wireless (e.g., cellular) technologies, these points of public communication have become underutilized facilities within the PSTN and have much greater bandwidth potential than their current application requires. As a result of the historical method of pay phone site selection and deployment, pay telephones exist in the majority of public venues. These are the very same locations that are potential high traffic areas for wireless data communication. Wireless Internet access is, for example, of particular interest to the consuming public.

A recent parallel development has been the invention of xDSL technology that allows simultaneous voice and computer communication on a PSTN local loop. This technology is typically combined with a PSTN local loop in a home or office environment to provide simultaneous Internet access and switched PSTN access, without mutual interference.

An additional development is the standardization of a wireless local area network (LAN) technology generally known as IEEE 802.11 (which includes 802.11a, 802.11b and other enhancements), or “Wi-Fi.” This technology provides a set of standardized specifications for wireless communications in LAN environments and allows subsequent Internet access. Several access providers are beginning to deploy 802.11 technologies in local areas that provide public Internet access utilizing this international wireless standard. Methods and systems for authentication, access control and security that are typically required to connect users to the Internet via 802.11 connections are known in the art and continue to evolve.

The exploding demand for wireless bandwidth is taxing the existing allocated frequency spectrum. Governmental bodies cannot allocate additional bandwidth quickly enough to keep pace with consumer and industry demand for wideband communication. The combination of pay telephones with wireless data communication technologies has the potential to alleviate this congestion by utilizing unregulated spectrum to access the Internet and enable high-speed application access in public areas.

### SUMMARY OF THE INVENTION

The present invention utilizes a combination of pay telephone and wireless data communication technologies to provide public wireless access to communications networks, including the Internet and/or other wide area or local area networks. A pay telephone provides a local PSTN loop that can be multiplexed to provide communications network access simultaneous with voice communication. In one exemplary implementation, data communications equipment (e.g., an xDSL router/modem) is connected to the pay telephone's local loop to provide Internet access through an Internet service provider. A passband filter/splitter can be used to provide filtering and line protection functions and enable simultaneous use of both the pay telephone and Internet access features.

A wireless access point (e.g., an 802.11 access point) added to the data communications equipment in the pay telephone provides wireless network connectivity for similarly-equipped mobile devices using standard access and authentication methods. Several resulting advantages of this invention are:

(1) public wireless access from existing and commonly-placed public pay telephones that are ubiquitously available in most common public locations;

(2) increased speed and bandwidth for wireless data communication that does not require additional allocation of scarce, government-controlled spectrum;

(3) improved utilization of pay telephone PSTN local loops to simultaneously provide pay telephone and communications network access;

(4) competition with cellular packet data services, with substantially higher speeds and potentially lower costs;

(5) conformance with existing form factors of public telephones and an easy and inexpensive upgrade path that provides substantial additional utility;

(6) a system that is based on internationally accepted standards and technology, including, but not limited to, 802.11, xDSL and public pay telephones; and

(7) an inexpensive and flexible public wireless access system that is a natural extension of existing infrastructure, such as the PSTN and the Internet.

### BRIEF DESCRIPTION OF THE DRAWING

The foregoing aspects and many of the attendant advantages of this invention will become more readily appreciated as the same become better understood by reference to the following detailed description, when taken in conjunction with the accompanying Figure, which depicts an overall architecture for one preferred implementation of the invention.

### List of Reference Numerals

1. Internet

2. Public Switched Telephone Network (PSTN)

3. Splitter/Filter

a. Direct Connected Splitter

b. Indirect Connected Splitter

4. Pay Telephone Equipment

5. Data Communications Equipment (e.g., xDSL Modem/Router)

6. Wireless Access Point (e.g., 802.11 Access Point)

7. Antenna(s)

8. Public Wireless Access System

9. Wireless User Access Device

### DETAILED DESCRIPTION OF A PREFERRED EMBODIMENT

One preferred embodiment of the invention is shown in the accompanying Figure, which depicts an overall architecture for this embodiment. The depicted public wireless access system (8) is comprised of a unique and inventive combination of existing, well-documented telecommunications and computer components to provide a system heretofore unknown.

A principal feature of this embodiment is that it provides public wireless access to communications networks, such as the Internet (1) through existing and new public switched telephone network (PSTN) facilities (2). This includes all forms of communication, for example, both voice and computer data. The terms “data” and “data communication” herein should be understood to include, without limitation, voice, video, text, e-mail, computer programs, script files, documents, messages, attachments, and any other type of information capable of being communicated.

Telephone equipment is connected to the PSTN network (2) to enable the placing of calls or interconnection to network systems, such as the Internet (1). Pay telephones (4) are one example of telephone equipment used in this manner. Pay telephones are placed in public locations to provide public access to the PSTN for a fee. Pay telephones typically include at least one PSTN local access loop.

An optional splitter/filter (3) can be connected between the PSTN (2) and the pay telephone equipment (4). The PSTN and telephone equipment connections may be of any type, including, for example, two-wire and four-wire connections. The splitter/filter (3) is connected on one side to the PSTN, usually using (but not required) a standard PSTN connection such as an RJ-11C jack. The splitter/filter (3) provides the telephone and data communications equipment discussed herein one or more filtered connections to the PSTN. The splitter/filter (3) supports simultaneous access to the PSTN and network systems, such as the Internet, across the same local loop facility. The splitter/filter (3) is also preferably configured to suppress interference.

Optional “plain old telephone system” (POTS) splitters allow the pay telephone local loop to be used for simultaneous high-speed digital subscriber line (DSL) transmission and single-line telephone service when the xDSL variant being used requires these devices. POTS splitters may be active or passive. A preferred implementation of the invention uses a standard, off-the-shelf, passive splitter, commonly called a microfilter, for the splitter/fitter (3). The specific model and type of the splitter/fitter (3) for a particular implementation may be determined according to the PSTN providers' specifications.

The splitter/filter (3) may alternatively be integrated into system connectors or into sub-systems such as the xDSL modem/router (5). In the latter implementation, the xDSL modem/router (5) may connect to the PSTN facility (2), and then passively pass a PSTN connection to the pay telephone equipment (4). Reference numeral (3a) in the Figure represents separate, in-line filter connections for the splitter/filter (3). Reference numeral (3b) depicts the data flow when the splitter/filter (3) is integrated with the modem/router (5). Selection of a particular model and type of modem/router (5) is well within the ability of one having ordinary skill in the art and may be determined, for example, from a list of approved equipment provided by the xDSL network provider.

In the embodiment of the invention shown in the Figure, the xDSL modem/router (5) constitutes data communications equipment that communicates data received from a wireless access point (6) to the PSTN (2). Other embodiments of the invention may use other data communications equipment, including, for example, cable modem equipment. The wireless access point (6), as shown, is preferably comprised of commercially-available computer hardware and operating software, e.g., hardware and software conforming to an IEEE 802.11 standard. The wireless access point (6) connects to antenna(s) (7) for wireless signal transmission and reception. The specific type and orientation of the antenna(s) (7) depends on the physical location and environment in which the access point (6) is placed. Some or all of the components depicted in the Figure may optionally be combined into a single unit or sub-system, if desired. Furthermore, specific models of each of the components (modem/router (5), 802.11 access point (6), and antenna (7)) may be selected so as to accommodate the physical location of the overall system, requirements of the PSTN and Internet service provider(s) (ISP(s)) being used, and the physical RF coverage needs of each location.

The present invention thus provides a public wireless access system (8) for connecting to network systems, using, for example, a physical combination of reference items (3-7) described above in connection with a pay telephone link to the PSTN. The public wireless access system (8) may enable users to access communications networks, including, but not limited to, local area, wide area, and/or global computer networks, such as the Internet (1). The communications networks may be public or private (e.g., owned or operated by multiple or single entities). The invention further provides a public wireless access system (8) having user authentication, access control and/or security systems for connecting users to one or more communications networks. Authentication, access control and security systems, which are typically required for users to connect to a communications network, are known in the art of computer networking and may be employed in embodiments of the invention. One generalized example of a network access process using an embodiment of the invention may involve the following steps:

Step 1—A wireless user access device (9) senses an available wireless connection with a network access point (6) (or the user requests a connection and the wireless user access device senses an available access point);

Step 2—The user is presented with an authentication/validation screen on the wireless user access device;

Step 3—The user enters an appropriate validation code or billing information (e.g., account name or credit card number);

Step 4—User access to a communications network, such as the Internet, is provided by a service provider, e.g., Internet service provider (ISP), and suitable billing tracking and monitoring processes are engaged (e.g., timer, packet counter, or transaction billing);

Step 5—The user conducts business and accesses or transmits information as desired; and

Step 6—The user disconnects and a billing log is posted.

The foregoing steps describe only one suitable process for using the present invention. The actions described above do not necessarily have to be performed in the manner or order as shown to achieve the advantages of the present invention. Alternative network access processes using the invention may employ additional or fewer steps than described above.

Individuals with 802.11-equipped access devices (9) are thus able to access network systems, such as the Internet, through the use of 802.11 access technology, methods and procedures. Examples of wireless user access devices that may be utilized in the invention include, but are not limited to:

Personal Computers

Personal Digital Assistants (PDAs)

Voice Over IP (VoIP) Hand-Sets

Telematics Devices

The present invention includes both construction of new pay telephones and retrofitting of existing pay telephones to provide wireless data communication in accordance with the invention. Retrofitting an existing pay telephone may be provided via a kit comprising data communications and wireless access point equipment for installation into the pay telephone. Different embodiments of a retrofitting kit may be provided to address different pay telephone configurations. In one embodiment, a kit for retrofitting a pay telephone includes data communications equipment in the form an xDSL modem/router, and wireless access point hardware and software in the form of an 802.11 wireless access point (with one or more antenna(s) as discussed above). The kit may also include a splitter or filter, or combination of the two, for installation into the pay telephone. Instructions provided with the kit preferably illustrate the connections of the equipment to the local access loop of the pay telephone to achieve wireless data communication via the pay telephone's PSTN connection in accordance with the present invention. In other embodiments, the kit may also include replacement housing for the pay telephone to accommodate a change in form factor of the telephone necessitated by the addition of the data communications equipment and wireless access point.

In another embodiment of the invention, the pay telephone equipment (4) shown in the Figure may be disabled or removed from the telephone housing, thus leaving the pay telephone with only wireless data communication capabilities. This embodiment of the invention may be desirable in locations having multiple pay telephones, where switched circuit access to the PSTN for conventional voice communication can be provided by other pay telephones, while pay telephones assembled according to the invention are dedicated exclusively to wireless data communication. An implementation of this embodiment of the invention may further include a replacement housing for the dedicated pay telephone that makes it more visible as an access point for wireless data communication. Such housing may use bold colors, styling, and/or signage. With a highly visible housing, consumers may more easily find and connect to the public wireless access system (8).

Implementations of the invention may also be scaled according to demand by connecting multiple wireless access points and/or data communications equipment as needed. In some locations where there is high demand, the public wireless access system (8) provided by the invention may thus be configured to accommodate numerous customers with simultaneous access to the PSTN (2) and communications networks, such as the Internet (1). This may occur in locations where people are frequently waiting, including for example, convention centers and transportation terminals. For instance, at an airport, people arriving early to catch an international flight may have several hours to wait for their flight. During that time, they may wish to access a computer network via the public wireless access system (8) to review news, download and respond to e-mails, communicate data, etc.

It should be understood from the description herein that the terms “connected” and “connection,” as used to described the links between the wireless access point (6), the data communications equipment (5), the telephone equipment (4), the splitter/filter (3), and the PSTN (2), include both direct and indirect connections. An example of a direct connection is where a physical port of one equipment is wired or engaged with a physical port of another. An example of an indirect connection is where one equipment can communicate with another via a path that includes some intermediate equipment.

Further implementations of the invention may be dedicated to specific businesses or entities. For example, a corporate campus may choose to install or retrofit one or more pay telephones with the public wireless access system (8) of the invention to provide their employees with mobile access to the corporation's communications networks, including corporate LANs or WANs, and/or the Internet. Another example is a university campus that replaces or retrofits pay telephones to provide students and faculty mobile access to the university's computer networks, including university LANs or WANs, and/or the Internet.

Implementations of the invention may also be designed for the bandwidth needs and/or level of demand of the location where the pay telephone is located. In some locations users connecting to the public wireless access system (8) may need only limited bandwidth for applications such as e-mail. The equipment of the public wireless access system (8) may be configured for low bandwidth needs. In other locations, users may require higher bandwidth for applications such as video. The present invention provides flexibility in the selection of the data communications equipment and wireless access points to accommodate these differing circumstances.

It is also noted that not all pay telephones may need to have the same amount of equipment added to it to provide the public wireless access system of the present invention. Some pay telephones currently have computer communication capabilities and may need only certain equipment, such as a wireless access point, to be added. Other pay telephones, typically older installations, are not computer capable and may need components as shown or further components in addition to or in place of the components shown in the accompanying Figure. Again, it should be understood from the description herein, the present invention is flexible to address these different needs and circumstances.

While preferred and alternative embodiments of a public wireless access system have been illustrated and described above, those of ordinary skill in the art will recognize that the concepts discussed above can be used in other embodiments without departing from the spirit and scope of the invention. The foregoing description is not intended to be exhaustive or to limit the invention to the precise form illustrated in the drawing or as specifically described. For example, while the preferred implementation is shown using a wireless access point (6) based on 802.11 technology, other embodiments of the invention may use wireless access equipment based on other data communication technologies. Further embodiments of the invention can be achieved using combinations of the concepts discussed herein and thus are also considered part of the present invention. For example, the pay telephone equipment (4) may be connected to the data communications equipment (5) and configured to communicate voice data via the PSTN (2) using signals transmitted through the data communications equipment (5). One example of this is a pay telephone configured to provide voice telephone calls using VoIP technology and the data communications equipment discussed herein. The scope of the invention should therefore be determined in reference to the following claims and equivalents thereto.

The embodiments of the invention in which an exclusive property or privilege is claimed are defined as follows:

1. A communications system comprising:
(a) a pay telephone connection to a public switched telephone network (PSTN);
(b) data communications equipment connected to the pay telephone connection, in which the data communications equipment is configured to provide data communication via the pstn; and
(c) a wireless access point connected to the data communications equipment, in which the wireless access point is configured to provide wireless communication that enables a wireless user access device to communicate data via the pay telephone pstn connection:

2. The communications system of claim 1, further comprising pay telephone equipment that is configured to enable a circuit switched telephone call to be placed simultaneous to data communication with the wireless user access device.

3. The communications system of claim 2, further comprising a splitter connected to the pay telephone PSTN connection, the splitter providing PSTN connections to both the pay telephone equipment and the data communications equipment.

4. The communications system of claim 2, in which the pay telephone equipment is connected to the pay telephone PSTN connection.

5. The communications system of claim 1, in which the pay telephone equipment is connected to the data communications equipment and communicates with the PSTN via the data communications equipment.

6. The communications system of claim 5, further comprising a splitter integrated with the data communications equipment and connected to the pay telephone PSTN connection to provide PSTN connections to both pay telephone equipment and the data communications equipment.

7. The communications system of claim 1, further comprising a filter connected to the pay telephone PSTN connection and configured to provide a PSTN connection with suppressed interference.

8. The communications system of claim 1, in which the wireless access point is further configured to enable the wireless user access device to connect to a communications network via the pay telephone PSTN connection.

9. The communications system of claim 8, in which the communications network is the Internet.

10. The communications system of claim 8, in which the communications network is a private network.

11. The communications system of claim 1, in which the data communications equipment includes digital subscriber line (DSL)-based equipment.

12. The communications system of claim 1, in which the wireless access point includes equipment conforming to an IEEE 802.11 standard.

13. A kit for retrofitting a pay telephone to provide wireless data communication, comprising:
(a) data communications equipment configured to be connected to a public switched telephone network (PSTN) connection of the pay telephone and provide data communication via the PSTN; and
(b) a wireless access point configured to be connected to the data communications equipment, in which the wireless access point provides wireless communication for a wireless user access device to communicate data via the PSTN connection of the pay telephone.

14. The kit of claim 13, further comprising a splitter configured to be connected to the PSTN connection of the pay telephone to provide PSTN connections to both the pay telephone and the data communications equipment.

15. The kit of claim 13, in which the data communications equipment is further configured to be connected to the pay telephone to enable placement of telephone calls via the data communications equipment simultaneous to data communication with the wireless user access device.

16. The kit of claim 13, further comprising a filter configured to be connected to the PSTN connection of the pay telephone for suppression of interference.

17. The kit of claim 13, in which the wireless access point is further configured to enable the wireless user access device to connect to a communications network via the PSTN connection of the pay telephone.

18. The kit of claim 17, in which the communications network is the Internet.

19. The kit of claim 17, in which the communications network is a private network.

20. The kit of claim 13, in which the data communications equipment includes digital subscriber line (DSL)-based equipment.

21. The kit of claim 13, in which the wireless access point includes equipment conforming to an IEEE 802.11 standard.

22. A method of providing wireless data communication using a pay telephone connection to a public switched telephone network (PSTN), comprising:
(a) connecting data communications equipment to the PSTN connection of the pay telephone, in which the data communications equipment is configured to provide data communication via the PSTN; and
(b) connecting a wireless access point to the data communications equipment, in which the wireless access point is configured to provide wireless communication that enables a wireless user access device to communicate data via the PSTN connection of the pay telephone.

23. The method of claim 22, further comprising connecting the data communications equipment to the pay telephone to enable placement of telephone calls via the data communications equipment simultaneous to data communication with the wireless user access device.

24. The method of claim 22, further comprising connecting a splitter to the PSTN connection of the pay telephone to provide PSTN connections to both the pay telephone and the data communications equipment.

25. The method of claim 22, further comprising connecting a filter to the PSTN connection of the pay telephone to suppress interference.

26. The method of claim 22, in which the wireless access point is configured to enable the wireless user access device to connect to a computer network via the PSTN connection of the pay telephone.

27. The method of claim 22, in which the data communications equipment includes digital subscriber line (DSL)-based equipment.

28. The method of claim 22, in which the wireless access point includes equipment conforming to an IEEE 802.11 standard.
